(19) United States
(12) Patent Application Publication
(10) Pub. No.: US 2015/0112500 A1
(43) Pub. Date: Apr. 23, 2015

(54) DEMAND RESPONSE SYSTEM HAVING A RENEWABLE ENERGY SOURCE

(71) Applicant: Honeywell International Inc., Morristown, NJ (US)

(72) Inventor: Edward Koch, San Rafael, CA (US)

(73) Assignee: Honeywell International Inc., Morristown, NJ (US)

(21) Appl. No.: 14/056,902

(22) Filed: Oct. 17, 2013

(51) Int. Cl. H02J 4/00

(52) U.S. Cl. CPC H02J 4/00
USPC 700/295

(57) ABSTRACT

A demand response management system having one or more renewable energy sources. The system may also have other kinds of energy sources. One or more demand response resources may be operated by a balancing authority. Sensors may be used to determine weather conditions so as to determine what may be expected in terms of power from the sources. Also, demand response resources may be incorporated for quick short term power balancing on a grid.

### BACKGROUND

The present disclosure pertains to energy system and particularly to demand response systems.

### SUMMARY

The disclosure reveals a demand response management system having one or more renewable energy sources. The system may also have other kinds of energy sources. One or more demand response resources may be operated by a balancing authority. Sensors may be used to determine weather conditions so as to determine what may be expected in terms of power from the sources. Also, demand response resources may be incorporated for quick short term power balancing on a grid.

### BRIEF DESCRIPTION OF THE DRAWING

FIG. 1 is a diagram of a basic demand response system;

FIG. 2 is a diagram of a demand response management system showing a demand response event; and

FIG. 3 is a diagram of a demand response management system utilizing renewable energy.

### DESCRIPTION

This description may provide one or more illustrative and specific examples or ways of implementing the present system and approach. There may be numerous other examples or ways of implementing the system and approach.

An effective resource is especially critical when communities are confronted with a scarcity of a resource in question. It may be noted that “resource” is a term that may have several senses or meanings. “Resource” may refer to energy, commodity, product, load, and so on. In another sense or meaning, “resource” such as a demand response (DR) resource may refer to a customer, a user, facility, and so on. In the first mentioned sense, it may refer to electricity, water, gas and natural resources such as oil. A definition of resource may be extended to include such things such as water quality and air quality. After all, adequate water quality and air quality appear necessary to support a self-sustaining environment.

Resource management, in both senses of “resource”, may be necessary so that systems can optimize the use of a limited resource. Currently, there are various systems for managing resources in various environments such as buildings, apartments, industrial facilities, and computing systems.

One mechanism that may be used to encourage customers to reduce demand and thereby reduce the peak demand for electricity may be referred to as demand response (DR). DR may refer to management of the demand by customers in response to supply conditions. For example, electricity customers may reduce their consumption at critical times and/or costs in response to market prices. These customers may be regarded as DR resources.

DR programs may require that a utility and/or independent service operator (ISO) deliver DR signals to participants via a communications channel. The programs may relate to a distribution of resources such as, but not limited to, electricity, water and natural gas.

DR signals may incorporate business level information, such as prices, reliability and shed levels. At some point, from the utility/ISO to loads in a facility, the business level information sent by the utility/ISO should be processed and used to execute a DR strategy and program for the facility.

DR programs may take many forms. They may differ from normal rates and tariffs in that the DR programs are designed to allow the utility/ISO take specific actions to influence the load profiles of facilities that participate in the DR programs at peak consumption times or periods on a grid. The peak consumption periods may cause critical grid reliability issues which should be addressed, but they may also trigger economic factors where the price of electricity or other power commodity reaches a critical level which may be ameliorated by reducing the overall consumption on the grid during those periods. The critical periods, in which the utility/ISO needs to influence a load profile of a facility, may be referred to as DR events.

A manner in which a utility/ISO may influence a load profile of a facility is to send out a DR signal which is specific to the DR event. DR signals may contain information related to business, controlling loads, and so on. There may be an automated DR where the DR signals that are sent out by the utility/ISO are responded to in an automated fashion. Loads within a facility may ultimately be affected by DR events via DR signals to which the facility acts upon or responds. The term “facility” may refer to virtually any location in which there are loads influenced by DR events. Where there are such loads may be regarded as a “DR resource”. The term “utility” may be used in a general sense to refer to a utility, independent system operator, service provider, and the like. It may be appropriate to use the term “demand side resource” in order to define a demand response resource.

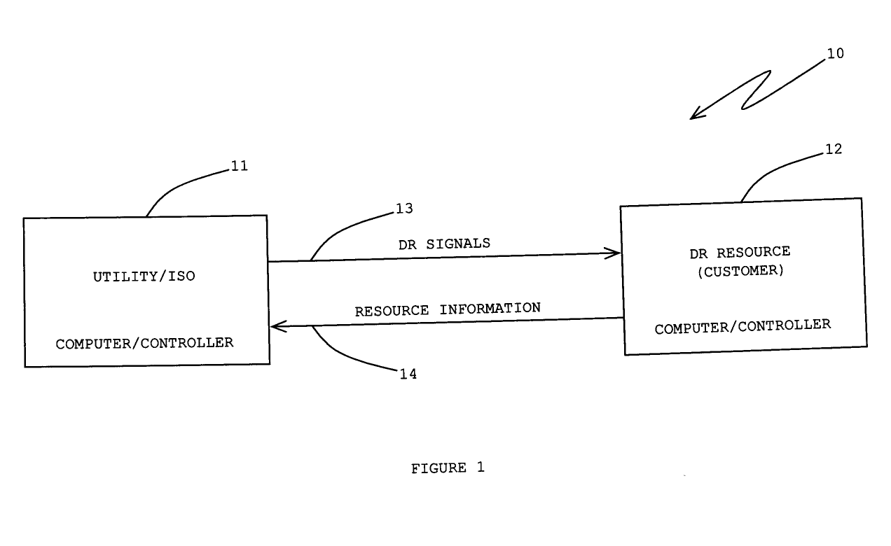

An implementation of DR signals within a “demand response management system” (DRMS) 10 is shown in a diagram of FIG. 1. System 10 and associated software may be effected and operated with one or more computers/controllers (controllers) 11, 12 and respective connections. The DRMS may be a system that is used by utilities/ISO's to manage the operation of DR programs. A focus of the DRMS may be on the operational aspects of managing the selection, signaling and monitoring of the DR resources that are participating in DR programs. The DRMS may be specifically designed to manage operations of automated DR programs.

There may be various types of interactions that could occur between the utility/ISO and a DR resource as part of a DR program. The diagram in FIG. 1 reveals an example interaction between a utility/ISO 11 and a DR resource (customer) 12. There may be DR signals 13 going from utility/ISO 11 to DR resource 12. There may be DR resource information 14, such as load measurements, going from DR resource 12 to utility/ISO 11.

Terms such as customer, client, user, participant, DR resource, and like terms, may be used, interchangeably or distinct from one another, depending on a context of a pertinent portion of a description or a claim.

A description of DR signals 13 may be noted. At a highest level, there may often be some sort of grid condition, be it economic or grid reliability in nature, which triggers a so-called DR event that requires some sort of interaction between the utility/ISO 11 and its customers 12. This interaction may eventually trigger some sort of load control taking place at a customer's facility. The interaction between the utility/ISO 11 and the customer 12 may be mediated by DR signals 13 and DR resource signals 14, i.e., information such as measurements. Signals 13 and 14 may represent communications between utility/ISO 11, and the DR resource or customer 12. Information contained within DR signals 13 may dictate where much of the decision-making takes place relative to, for example, in how the initial grid condition, which triggered the DR event, results in the eventual load control.

The present system and approach may incorporate one or more processors, computers, controllers, user interfaces, wireless and/or wire connections, and/or the like, in an implementation described and/or shown herein.

A computer or controller may incorporate one or more inputs, a processor, a user interface incorporating a keyboard, a display and a touch screen, a memory, external connections such as an internet, one or more outputs, and so forth. The computer may be utilized with virtually all items in and pertinent to FIGS. 1-3.

This description may provide one or more illustrative and specific examples or ways of implementing the present system and approach. There may be numerous other examples or ways of implementing the system and approach.

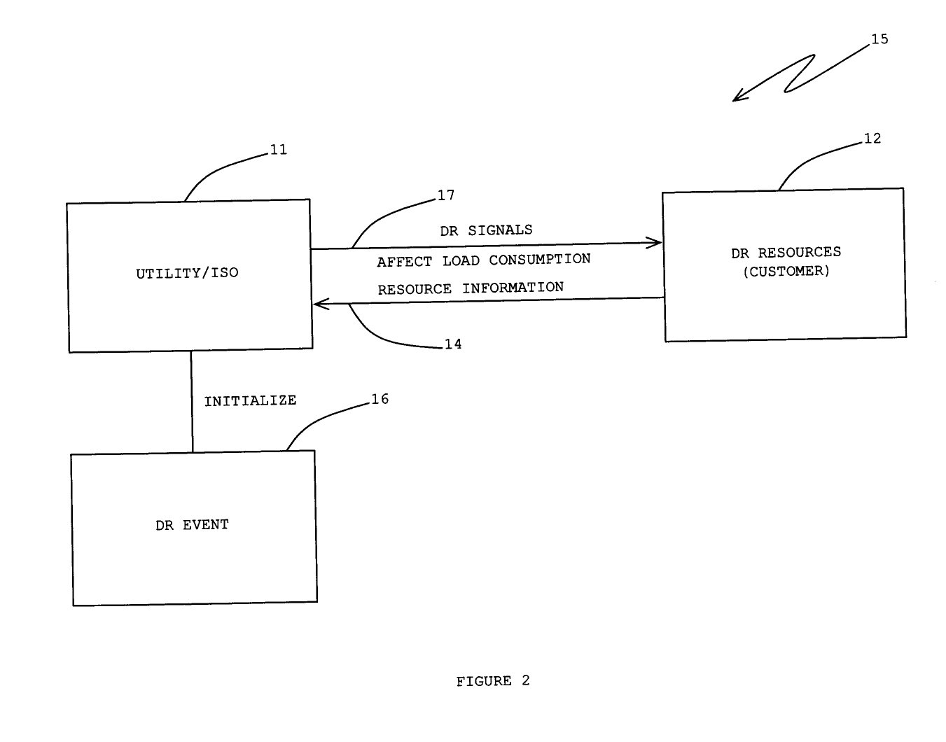

Automated demand response (ADR) programs may be used in a number of different customer market segments ranging from large commercial and industrial to small commercial and residential. A diagram of FIG. 2 shows a layout 15 of a utility/ISO 11 and DR resources 12. Utility/ISO 11 may enroll customers into demand response (DR) programs and model them as so called DR resources 12 that they can call upon when it is necessary for utility 11 to initiate a DR event 16. Calling upon a DR resource 12 typically means that the utility/ISO 11 “dispatches” the DR resources by sending them DR signals 17 which affect their load consumption in some predictable fashion. Information signals 14 may go from DR resources 12 to utility/ISO 11.

A pre-cursor to initiating a DR event 16 is the establishment of a set of objectives that need to be accomplished during the DR event. Such objectives may include the following items: 1) A specific amount of load response over some period of time (load responses may entail both reduced and increased levels of consumption); 2) Loads associated with a specific grid and/or geographic locations; 3) A specific type of loads; and 4) Loads with minimum response times and latencies.

When a utility 11 initiates a DR event 16, the utility may typically select some subset of the available DR resources 12 from the collection of all possible DR resources that meets the objectives as outlined above. Each DR resource 12 may have both capabilities and associated costs with using that resource during an event so the problem to be solved is how best to minimize the overall cost of a collection of DR resources while still using their capabilities to satisfy the overall objectives of the DR event 16. Furthermore, in the case of so called “Fast DR”, which may require dispatches to happen in real time, it may be necessary that the DR resource 12 selection process be automated and not require human operator involvement.

The use of so called intermittent renewable resources (IRR) may become more prevalent as a source of electricity generation. IRR may incorporate such resources as solar and wind generation. Other resources may be incorporated. By their very nature, the output of such generation of resources may be strongly dependent upon weather conditions.

When the output of the IRR's varies, it may be necessary to change the output of other one or more generations and/or the amount of electricity consumed by demand response resources in order to keep the electric grid balanced. Such balancing responsibilities may be performed either by a centralized balancing authority such as an independent system operator (ISO) or may be done locally near the IRR itself so that the net output of the IRR is less variable from the perspective of other entities on the grid.

Weather forecasts may play a key role in the planned usage of IRR's, but accurately predicting the weather appears very difficult and short term, and unexpected fluctuations may still occur. During such short term unexpected weather events, it may be necessary to quickly bring to bear resources that can be used to balance the changes in the IRR output. This may be done by metering the power generated by the IRR and responding accordingly when it fluctuates from expected values. The present approach may further improve upon that methodology by using demand response resources that respond to weather conditions before the output of the IRR is actually affected thus giving the other DR resources more time to respond to the inevitable fluctuations in the IRR caused by weather conditions.

The use of demand response resources for a purpose described herein may be referred to as demand response (DR) and the automated use of such resources could be regarded as an automated demand response (ADR). In the case of ADR, there may exist some entity that calls upon a DR resource by sending it a so-called DR signal that causes the DR resource to automatically change its load consumption by either consuming less or more electricity, depending upon the information that is in the DR signal.

When it is necessary to utilize a DR resource, this necessity may be typically referred to as a DR event. The solution described herein may link the initiation of DR events to real-time weather conditions. Unlike the use of longer term weather forecasts to predict and plan the use of various resources to balance fluctuations in IRR output, the present approach solution may use real time weather conditions to trigger DR events. Furthermore, the solution may link specific DR resources to specific IRR's and the weather conditions at the IRR.

The present solution may rely upon ADR resources. This reliance may mean that the control of load consumption at the DR resources is automated such that when a DR event is initiated, a DR signal is sent to the DR resource which results in an automated change in the DR resources load consumption. This may allow for a very fast response by the DR resources.

Furthermore, the DR resource may be programmed to both increase and decrease its load consumption depending upon the nature of the fluctuation at the IRR.

The benefits of such an approach may include the following items: 1) Better able to handle unexpected fluctuations in the IRR by responding before the output of the IRR changes; 2) Ability to couple DR resources with specific IRR's such that the balancing activities can be performed by the IRR owner instead of a more centralized balancing authority such as an ISO; 3) Can be used to offset both increased and decreased output from the IRR.

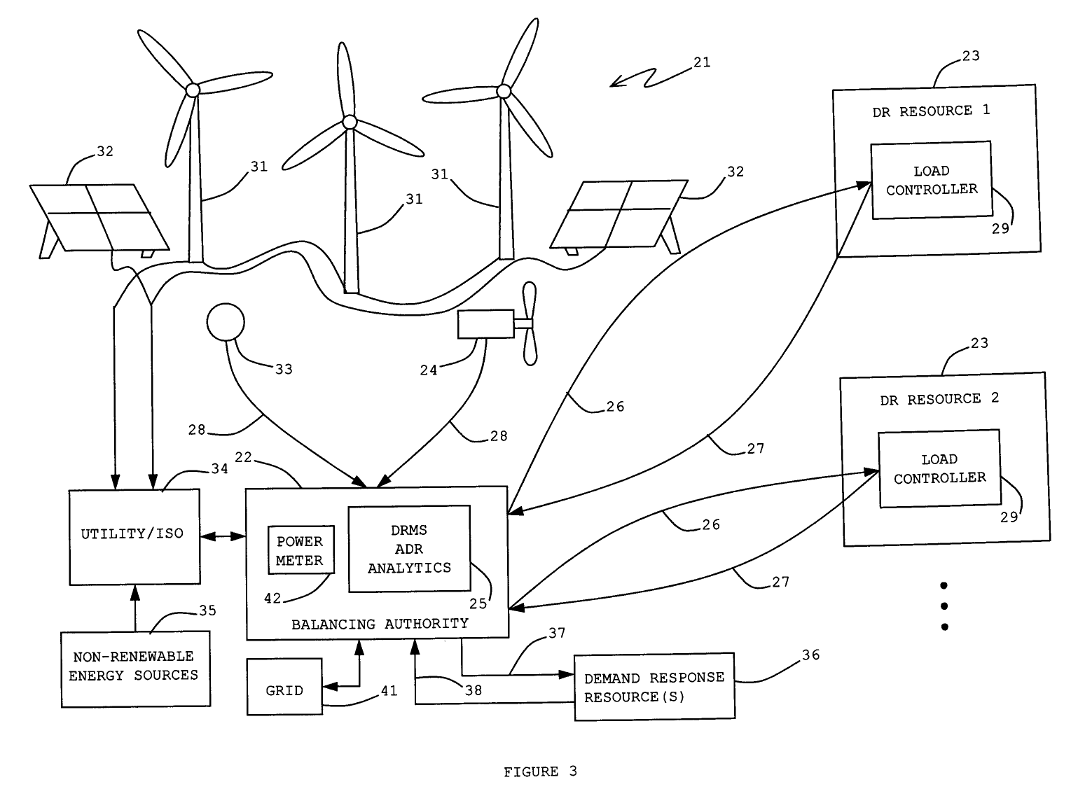

FIG. 3 is a diagram that illustrates the present approach. The present solution may incorporate following subsystems. 1) An IRR—For the sake of illustration, a wind farm 21 of wind driven electric generators or wind turbines 31 is shown, but other types of IRR's such as solar energy may be supported. 2) A balancing authority 22—This may be an entity that is responsible for responding to fluctuations in the IRR by calling upon other resources to offset the changes in the IRR output. Balancing authority 22 may be either centralized such as an ISO or it may be local and specific to the IRR itself. The balancing authority may use a demand response management system (DRMS) 25 to manage DR resources 23 under its control and send DR signals 26 to those resources 23 when necessary. 3) DR resources 23—These are a collection of one or more resources that are called upon to help balance fluctuations in the output of the IRR.

The present approach may use the following steps. 1) Use strategically placed instruments near the IRR to measure relevant weather conditions. In the case of wind farm 21, this might entail using one or more sensors or anemometers 24 that are placed around wind farm 21 to detect changes in wind speed 28 before those effects occur at wind turbines 31. In a case of a field of solar cells 32, this might entail using a sensor or detector 33 to detect changes in cloud cover and available sunlight.

2) Weather conditions may be continuously sent to DRMS 25 that is operated by balancing authority 22. DRMS 25 may perform analytics 25 using the weather data to predict what the near-term output of the IRR will be. Such analytics 25 may be based upon a variety of forecasting models that utilize past weather data and IRR behavior and do regression analysis. 3) Using the weather data, if DRMS 25 determines that there is an unexpected near-term change in the output of the IRR; DRMS 25 may automatically initiate a DR event and send a DR signal 26 to DR resources 23. DR resources 23 that are selected to participate in the DR event may be those that have been pre-determined to be used for particular IRR's. In addition, DRMS 25 may select only a subset of DR resources 23 in order to optimize the aggregated response of virtually all DR resources 23 to best mitigate the anticipated IRR output fluctuation. DR signal 26 may take many forms and could be anything ranging from a price incentive to an explicit dispatch that instructs DR resource 23 precisely how it should change its consumption. Furthermore, DRMS 25 may use a variety of emerging standards such OpenADR 25 to send DR signal 26. 4) Upon receiving DR signal 26, DR resource 23 may respond in some pre-programmed (i.e., automated) fashion to change its load consumption appropriately. This may entail DR resource 23 either increasing or decreasing its consumption. A duration of its response may be dictated by parameters within DR signal 26 as determined by DRMS 25. 5) Optionally, DR resource 23 may provide some sort of feedback 27 to DRMS 25 which indicates how DR resource 23 is performing in response to DR signal 26. Feedback 27 may take many forms and can range from metered load consumption data to state information about the load control by a load controller 29. 6) DRMS 25 may use feedback 27 from DR resource 23 to determine if it is responding as expected. If not, then DRMS 25 may decide to modify DR signal 26 being sent to DR resource 23 or DRMS 25 may decide to call upon other DR resources 23.

A utility/ISO 34 may be connected to balancing authority 22. Renewable energy such as wind and solar energy may be fed from wind turbines 31 and solar cells 32, respectively, to utility/ISO 34. Similarly, non-renewable energy may be fed from sources 35 to utility/ISO 34.

Demand response resource(s) 36 may be utilized for quick and/or short term energy and/or grid 41 adjustments. Demand response resource signals 37 may be sent from balancing authority 22 to one or more demand response resources 36 for decreased or increased load adjustments. Feedback signals 38 from one or more demand response resources 36 may provide information about action and status of resources 36 to balancing authority 22.

A power meter 42 may be utilized to measure and monitor energy from the renewable and non-renewable energy sources. Meter 42 may aid in measuring and monitoring the power on grid 41. Load consumption as related to DR resources may be measured and monitored by meter 42.

Demand response resource(s) 36 may be utilized for quick and/or short term energy and/or grid 41 adjustments. An example may be a sensor 24 or 33 that may detects an environmental change that eventually affects an output of the renewable energy source 31 or 32. Balancing authority processor 22 may bring in the at least one demand response resource 36 for balancing the output before the output of the renewable energy source 31 or 32 is affected by the environmental changes detected by sensor 24 or 33, respectively. Balancing authority processor 22 may bring in another at least one demand response resource 23 to balance the output of the renewable energy source after the output of the renewable energy source 31 or 32 is affected by the environmental changes. An effective response by a demand response resource 36 may or may not necessarily be faster than that by a demand response resource 23. There may be situations where it is advantageous for demand response resource 36 to be faster than demand response resource 23, or vice versa. A demand response resource 36 and a demand response resource 23 may reverse roles or have the same roles for providing a response.

While the description herein may describe a specific type of IRR and an approach of measuring weather conditions (i.e., an anemometer), a variety of approaches of measuring weather conditions near the IRR may be used. Such measurements may include satellite and radar techniques. A main requirement may incorporate approaches that can reliably measure and predict the near term effect on the weather conditions that are relevant to the operations of the IRR. In the case of wind generation, that may be wind speed. In the case of solar generation, it may be available sun light.

To recap, a demand response system for renewable energy may incorporate a renewable energy source, a balancing authority processor connected to the renewable energy source, a power meter connected to the renewable energy source, at least one demand response resource connected to the balancing authority processor, and a sensor, situated in the area of the renewable energy source, connected to the balancing authority processor.

The sensor may detect an environmental change that eventually affects an output of the renewable energy source. The balancing authority processor may bring in the at least one demand response resource for balancing the output before the output of the renewable energy source is affected by the environmental changes detected by the sensor.

The balancing authority processor responds to changes of an output of the renewable energy source with the at least one demand response resource and brings in another at least one demand response resource to balance the output of the renewable energy source after the output of the renewable energy source is affected by the environmental changes.

The balancing authority processor may use a demand response management subsystem to manage the at least one demand response resource. The demand response management subsystem may send a DR signal to the at least one DR resource to cause the at least one DR resource to increase or decrease its consumption. The at least one DR resource provides a feedback signal to the DR management subsystem. The feedback signal indicates how the DR resource is performing in response to the DR signal.

The at least one DR resource may incorporate a load controller. The load controller may provide information about load consumption and control in response to the DR signal.

The DR management subsystem may use the feedback signal to decide whether to modify the DR signal or to call upon other DR resources.

An approach of using environmental conditions to trigger demand response events, may incorporate providing an amount of energy from one or more renewable energy sources, sensing in real time one or more conditions that can change the amount of energy from the one or more renewable energy sources, using one or more demand response resources to respond to the one or more conditions sensed in real time before a change of the amount of energy from the one or more renewable energy sources occurs due to the one or more conditions, and using one or more DR resources to respond to changes of the amount of energy from the one or more renewable energy sources due to the one or more conditions, when the changes of the amount of energy from the one or more renewable energy sources occur.

The approach may further incorporate changing an output from non-renewable energy sources, when the amount of energy from the one or more renewable energy sources changes, to maintain a constant amount of power available for consumption.

The one or more DR resources may be coupled to specific one or more renewable energy sources in that a balancing of the load of the one or more DR resources with energy from the one or more renewable energy sources can be performed by an owner or custodian of the one or more renewable energy sources.

The approach may further incorporate using a DR management system, when one or more conditions sensed in real time affect an amount of energy from the one or more renewable energy sources, to automatically incorporate the one or more demand response resources that respond to the one or more conditions before the energy from the one or more renewable energy sources changes in response to the one or more conditions.

The one or more conditions may trigger a DR event. When a DR event is triggered, a DR management system may send a DR signal to the one or more demand response resources. The DR signal may results in a change of consumption of energy by the one or more DR resources.

A DR management system may be programmed to automatically increase or decrease load consumption by the one or more DR resources in accordance with changes in the amount of energy from the one or more renewable energy sources to result in a constant amount of energy available.

A renewable energy demand response mechanism may incorporate one or more demand response (DR) resources, a utility, one or more renewable energy sources connected to the utility, and a demand response management system connected to the utility and the one or more DR resources.

The demand response management system may balance an electric grid relative to energy from the one or more renewable energy sources and the other energy sources, and a consumption of energy by the one or more DR resources.

The mechanism may further incorporate another one or more demand response resources, one or more sensors to detect conditions that can affect an amount of energy from the one or more renewable energy sources. If the conditions that can affect an amount of energy from the one or more renewable energy sources occur, then the DR management system may use the other one or more demand response resources that respond to the conditions before the energy from the one or more renewable energy sources changes in response to the conditions.

The DR resources may have a greater amount of time to respond to eventual changes of the energy from the one or more renewable energy sources than an amount of time that the other one or more demand response resources take to respond to the conditions.

If the conditions are real time, the conditions may trigger a DR event. When a DR event is triggered, the DR management system may send a DR signal to the one or more demand response resources. The DR signal may result in a change of consumption of energy by the one or more DR resources. The change of consumption can be automatic. The one or more DR resources may be programmed to increase or decrease load consumption in accordance with changes in the amount of energy from the one or more renewable energy sources.

The one or more DR resources may be coupled to a specific one or more renewable energy sources in that a balancing of the load of the one or more DR resources with energy from the one or more renewable energy sources can be performed locally by an owner or custodian of the one or more renewable energy sources.

Several documents relevant to the present application may incorporate U.S. patent application Ser. No. 13/272,086, filed Oct. 12, 2011, and entitled “Use of Aggregated Groups for Managing Demand Response Resources”; U.S. patent application Ser. No. 13/939,935, filed Jul. 11, 2013, and entitled “Optimizing a Selection of Demand Response Resources”; U.S. patent application Ser. No. 13/940,043, filed Jul. 11, 2013, and entitled “Predicting Responses of Resources to Demand Response Signals and Having Comfortable Demand Responses”; and U.S. patent application Ser. No. 13/940,066, filed Jul. 11, 2013, and entitled “An Arrangement for Communicating Demand Response Resource Incentives”.

U.S. patent application Ser. No. 13/272,086, filed Oct. 12, 2011, and entitled “Use of Aggregated Groups for Managing Demand Response Resources”; U.S. patent application Ser. No. 13/939,935, filed Jul. 11, 2013, and entitled “Optimizing a Selection of Demand Response Resources”; U.S. patent application Ser. No. 13/940,043, filed Jul. 11, 2013, and entitled “Predicting Responses of Resources to Demand Response Signals and Having Comfortable Demand Responses”; and U.S. patent application Ser. No. 13/940,066, filed Jul. 11, 2013, and entitled “An Arrangement for Communicating Demand Response Resource Incentives” are all hereby incorporated by reference.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to include all such variations and modifications.

What is claimed is:

1. A demand response system for renewable energy comprising:
a renewable energy source;
a balancing authority processor connected to the renewable energy source;
a power meter connected to the renewable energy source;
at least one demand response resource connected to the balancing authority processor; and
a sensor, situated in the area of the renewable energy source, connected to the balancing authority processor; and
wherein:
the sensor detects an environmental change that eventually affects an output of the renewable energy source; and
the balancing authority processor brings in the at least one demand response resource for balancing the output before the output of the renewable energy source is affected by the environmental changes detected by the sensor.

2. The system of claim 1, wherein the balancing authority processor responds to changes of an output of the renewable energy source with the at least one demand response resource and brings in another at least one demand response resource to balance the output of the renewable energy source after the output of the renewable energy source is affected by the environmental changes.

3. The system of claim 1, wherein the balancing authority processor uses a demand response management subsystem to manage the at least one demand response resource.

4. The system of claim 3, wherein the demand response management subsystem sends a demand response signal to the at least one demand response resource to cause the at least one demand response resource to increase or decrease its consumption.

5. The system of claim 4, wherein the at least one demand response resource provides a feedback signal to the demand response management subsystem.

6. The system of claim 5, wherein the feedback signal indicates how the demand response resource is performing in response to the demand response signal.

7. The system of claim 4, wherein:
the at least one demand response resource comprises a load controller; and
the load controller provides information about load consumption and control in response to the demand response signal.

8. The system of claim 5, the demand response management subsystem uses the feedback signal to decide whether to modify the demand response signal or to call upon other demand response resources.

9. A method of using environmental conditions to trigger demand response events, comprising:
providing an amount of energy from one or more renewable energy sources;
sensing in real time one or more conditions that can change the amount of energy from the one or more renewable energy sources;
using one or more demand response resources to respond to the one or more conditions sensed in real time before a change of the amount of energy from the one or more renewable energy sources occurs due to the one or more conditions; and
using one or more demand response resources to respond to changes of the amount of energy from the one or more renewable energy sources due to the one or more conditions, when the changes of the amount of energy from the one or more renewable energy sources occur.

10. The method of claim 9, further comprising changing an output from non-renewable energy sources, when the amount of energy from the one or more renewable energy sources changes, to maintain a constant amount of power available for consumption.

11. The method of claim 9, wherein the one or more demand response resources are coupled to specific one or more renewable energy sources in that a balancing of the load of the one or more demand response resources with energy from the one or more renewable energy sources can be performed by an owner or custodian of the one or more renewable energy sources.

12. The method of claim 9, further comprising using a demand response management system, when one or more conditions sensed in real time affect an amount of energy from the one or more renewable energy sources, to automatically incorporate the one or more demand response resources that respond to the one or more conditions before the energy from the one or more renewable energy sources changes in response to the one or more conditions.

13. The method of claim 9, wherein:
the one or more conditions can trigger a demand response event;
when a demand response event is triggered, a demand response management system sends a demand response signal to the one or more demand response resources; and
the demand response signal results in a change of consumption of energy by the one or more demand response resources.

14. The method of claim 9, wherein a demand response management system is programmed to automatically increase or decrease load consumption by the one or more demand response resources in accordance with changes in the amount of energy from the one or more renewable energy sources to result in a constant amount of energy available.

15. A renewable energy demand response mechanism comprising:
one or more demand response resources;
a utility;
one or more renewable energy sources connected to the utility; and
a demand response management system connected to the utility and the one or more demand response resources; and
wherein the demand response management system balances an electric grid relative to energy from the one or more renewable energy sources and the other energy sources, and a consumption of energy by the one or more demand response resources.

16. The mechanism of claim 15, further comprising:
another one or more demand response resources;
one or more sensors to detect conditions that can affect an amount of energy from the one or more renewable energy sources; and
wherein if the conditions that can affect an amount of energy from the one or more renewable energy sources occur, then the demand response management system uses the other one or more demand response resources that respond to the conditions before the energy from the one or more renewable energy sources changes in response to the conditions.

17. The mechanism of claim 16, wherein the demand response resources have a greater amount of time to respond to eventual changes of the energy from the one or more renewable energy sources than an amount of time that the other one or more demand response resources take to respond to the conditions.

18. The mechanism of claim 16, wherein:
if the conditions are real time, the conditions can trigger a demand response event;
when a demand response event is triggered, the demand response management system sends a demand response signal to the one or more demand response resources;
the demand response signal results in a change of consumption of energy by the one or more demand response resources; and
the change of consumption can be automatic.

19. The mechanism of claim 18, the one or more demand response resources can be programmed to increase or decrease load consumption in accordance with changes in the amount of energy from the one or more renewable energy sources.

20. The mechanism of claim 15, wherein the one or more demand response resources are coupled to a specific one or more renewable energy sources in that a balancing of the load of the one or more demand response resources with energy from the one or more renewable energy sources can be performed locally by an owner or custodian of the one or more renewable energy sources.
